(19) United States
(12) Patent Application Publication
(10) Pub. No.: US 2022/0289966 A1
(43) Pub. Date: Sep. 15, 2022

(54) COMPLEX, METHOD FOR MANUFACTURING MOLDED PRODUCT, AND MOLDED PRODUCT

(71) Applicant: SEIKO EPSON CORPORATION, Tokyo (JP)

(72) Inventors: Takumi SAGO, Matsumoto (JP); Yoshihiro UENO, Shiojiri (JP); Hiroki KURATA, Matsumoto (JP)

(21) Appl. No.: 17/693,482

(22) Filed: Mar. 14, 2022

(30) Foreign Application Priority Data
Mar. 15, 2021 (JP) 2021-041091

(51) Int. Cl. C08L 67/00; B29D 7/01

(52) U.S. Cl. CPC C08L 67/00; B29D 7/01; B29K 2101/12

(57) ABSTRACT

The complex of the present disclosure includes a thermoplastic particle constituted of a thermoplastic material and an inorganic particle surface-treated with at least one surface treatment agent selected from the group consisting of fluorine-containing compounds and silicon-containing compounds and further includes a composite particle composed of the thermoplastic particle and the inorganic particle adhered to the thermoplastic particle.

The present application is based on, and claims priority from JP Application Serial Number 2021-041091, filed Mar. 15, 2021, the disclosure of which is hereby incorporated by reference herein in its entirety.

### BACKGROUND

### 1. Technical Field

The present disclosure relates to a complex, a method for manufacturing a molded product, and a molded product.

### 2. Related Art

Obtaining a sheet-like or film-like molded product by depositing a fibrous material and exerting a binding force between the deposited fibers has been performed for a long time. As a typical example thereof, manufacturing of paper by papermaking using water is mentioned. The paper manufactured by a papermaking method generally, for example, often has a structure in which the fibers of cellulose derived from wood, etc. are entwined with each other and partially bound to each other by a binder.

However, since the papermaking method is a wet method, it is necessary to use a large amount of water. In addition, dehydration, drying, etc. are necessary after formation of paper, and the energy and time to be spent for them are very large. Furthermore, the used water is required to be adequately treated as wastewater. Accordingly, it has become difficult to respond to recent requirements, such as energy saving and environmental protection. In addition, the apparatus to be used for the papermaking method often needs water, electricity, and a large-scale utility such as a drainage facility, and downsizing is difficult. From these viewpoints, as a method for manufacturing paper replacing the papermaking method, a method using no or little water called a dry method is expected.

As such a dry method, known is a method using a fiber and a binder for improving the strength of resulting paper and incluing depositing a mixture of the fiber and the binder to form a web and pressurizing and heating the web to form a sheet (for example, see International Publication No. WO 2018/043034).

However, as described above, when a mixture of a fiber and a resin is merely heated and pressurized, the wetting and spreading of the resin is insufficient, the adhesive area between individual fibers is small, and it may be difficult to sufficiently secure the strength of the sheet as a molded product.

### SUMMARY

The present disclosure has been made to solve the above-mentioned problems and can be realized as the following application examples.

A complex according to an application example of the present disclosure comprises:
a thermoplastic particle constituted of a thermoplastic material; and
an inorganic particle surface-treated with at least one surface treatment agent selected from the group consisting of fluorine-containing compounds and silicon-containing compounds, wherein
the complex further comprises a composite particle composed of the thermoplastic particle and the inorganic particle adhered to the surface of the thermoplastic particle.

A method for manufacturing a molded product according to another application example of the present disclosure comprises:
a deposition step of depositing a mixture including a fiber and the complex according to the application example of the present disclosure; and
a heating and pressurization step of heating and pressurizing the mixture.

A molded product according to another application example of the present disclosure comprises:
a fiber;
an inorganic particle surface-treated with at least one surface treatment agent selected from the group consisting of fluorine-containing compounds and silicon-containing compounds; and
a thermoplastic material for binding the fiber and the inorganic particle.

### BRIEF DESCRIPTION OF THE DRAWINGS

FIG. 1 is a view schematically showing a complex of an appropriate embodiment of the present disclosure.

FIG. 2 is a schematic side view illustrating the structure of a manufacturing apparatus of a molded product of an appropriate embodiment.

FIG. 3 is a drawing showing the steps implemented sequentially by the manufacturing apparatus of a molded product shown in FIG. 2.

### DESCRIPTION OF EXEMPLARY EMBODIMENTS

Appropriate embodiments of the present disclosure will now be described in detail.

### 1. Complex

First, the complex of the present disclosure will be described.

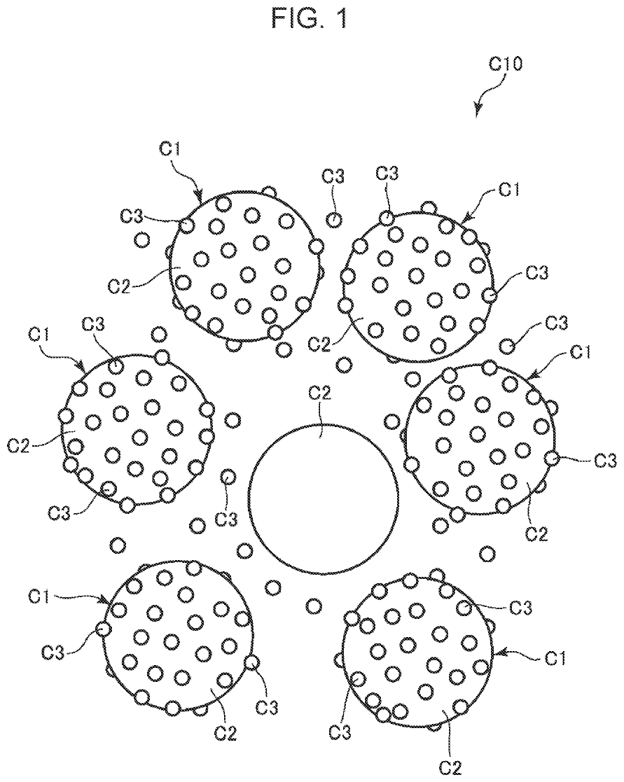

FIG. 1 is a view schematically showing a complex of an appropriate embodiment of the present disclosure.

The complex C10 of the present disclosure includes a thermoplastic particle C2 constituted of a thermoplastic material and an inorganic particle C3 surface-treated with at least one surface treatment agent selected from the group consisting of fluorine-containing compounds and silicon-containing compounds. The complex C10 further includes a composite particle C1 composed of the thermoplastic particle C2 and the inorganic particle C3 adhered to the surface of the thermoplastic particle C2. In other words, at least a part of particles of the inorganic particle C3 included in the complex C10 is adhering to the surface of the thermoplastic particle C2.

Consequently, it is possible to provide a complex C10 that can be suitably used in manufacturing of a molded product including a fiber and having an excellent strength. In addition, a molded product having a desired shape can be suitably manufactured even if almost no water is used. That is, the method can be suitably applied to a dry molding method. Accordingly, the method is advantageous also from the viewpoint of the productivity and production cost of the molded product, energy saving, downsizing of the facility for manufacturing a molded product, and so on. Incidentally, in the present specification, the “dry molding method” refers to a method in which a raw material for molding is not immersed in a liquid including water in the process of manufacturing a molded product, and a method using a small amount of water, such as a method of spraying a liquid including water to a raw material for molding, etc., is included in the dry molding method.

It is inferred that these excellent effects are obtained by the following reasons.

That is, the surface free energy can be reduced by including the surface-treated inorganic particle C3 attached on the surface of the thermoplastic particle C2, compared to the case of using a thermoplastic particle alone, i.e., using a thermoplastic particle to which no inorganic particle is adhered or the case of attaching an inorganic particle not subjected to a surface treatment to a thermoplastic particle. As a result, when heating is performed in manufacturing of a molded product using a fiber, the complex C10 is likely to suitably wet and spread on the surface of the fiber. Consequently, in the finally obtained molded product, the adhesion between the fiber and the thermoplastic material is improved, and the molded product can have an excellent strength.

In addition, aggregation of the thermoplastic particle C2 and the composite particle C1 can be suitably prevented by using the inorganic particle C3 surface-treated with a surface treatment agent mentioned above. In addition, the fluidity and ease of handling of the complex C10 are improved by including the inorganic particle C3 surface-treated by the surface treatment agent mentioned above. Consequently, the productivity of the molded product can be particularly improved.

### 1-1. Composite Particle

The complex C10 includes a composite particle C1 composed of the thermoplastic particle C2 and the inorganic particle C3 adhered to the surface of the thermoplastic particle C2.

Although the composite particle C1 included in the complex C10 may be composed of a single particle of the thermoplastic particle C2 and a single particle of the inorganic particle C3 adhered to the surface of the thermoplastic particle C2, the complex C10 may include a particle as the composite particle C1 composed of a single particle of the thermoplastic particle C2 and a plurality of particles of the inorganic particle C3 adhered to the surface of the thermoplastic particle C2.

Consequently, the effects described above are more remarkably exerted.

The average particle diameter of the composite particle C1 may be 1.0 μm or more and 100 μm or less, 2.0 μm or more and 70 μm or less, or 3.0 μm or more and 50 μm or less.

Consequently, the effects described above are more remarkably exerted.

Incidentally, in the present specification, the term “average particle diameter” refers to the volume-based average particle diameter unless otherwise specified. The average particle diameter can be determined by measurement using, for example, a Nanotrac UPA (manufactured by Nikkiso Co., Ltd.).

### 1-1-1. Thermoplastic Particle

The thermoplastic particle C2 is constituted of a thermoplastic material.

Examples of the thermoplastic material constituting the thermoplastic particle C2 include styrene-based resins, such as polystyrene, an acrylonitrile-styrene copolymer, and an acrylonitrile-butadiene-styrene copolymer; various thermoplastic resins, such as an acrylic resin, a styrene-acrylic copolymer resin, an olefin resin, a vinyl chloride resin, a polyester resin, a polyamide resin, a polyurethane resin, and a polyvinyl alcohol resin; and thermoplastic starch, and one or a combination of two or more selected from these thermoplastic materials can be used. In particular, the thermoplastic material may be a thermoplastic resin or polyester.

Consequently, the conditions, such as the glass transition point and melting point, of the thermoplastic particle C2 can be more suitbaly controlled, and the reliability of the molded product manufactured using the complex C10 can be further improved. In addition, it is also advantageous in suppressing the manufacturing cost of the complex C10 and the manufacturing cost of the molded product.

The thermoplastic particle C2 may include a component not having thermoplasticity, in addition to the thermoplastic material, as long as the thermoplastic particle C2 has thermoplasticity as a whole. Examples of such the component include a textile material, a colorant, and a flame retardant.

However, the content of the thermoplastic material in the thermoplastic particle C2 may be 80 mass % or more, 90 mass % or more, or 95 mass % or more.

The average particle diameter of the thermoplastic particle C2 may be 1.0 μm or more and 100 μm or less, 1.0 μm or more and 60 μm or less, or 2.0 μm or more and 40 μm or less.

Consequently, the fluidity and ease of handling of the complex C10 are further improved, the fiber and the complex C10 can be more suitbaly mixed when a molded product is manufactured, unintentional variation, etc. in the composition in the manufactured molded product can be suppressed, and the strength, reliability, and so on of the molded product can be more improved.

The complex C10 may include the thermoplastic particle C2 to which the inorganic particle C3 does not adhere, in other words, the thermoplastic particle C2 not constituting the composite particle C1 may be included, but the proportion of the thermoplastic particle C2 constituting the composite particle C1 in the whole thermoplastic particle C2 included in the complex C10 can be 50 mass % or more, 60 mass % or more, or 70 mass % or more.

Consequently, the above-described effects of the present disclosure are more remarkably exerted.

### 1-1-2. Inorganic Particle

The composite particle C1 includes an inorganic particle C3 surface-treated with at least one surface treatment agent selected from the group consisting of fluorine-containing compounds and silicon-containing compounds. In other words, the inorganic particle C3 includes a mother particle constituted of an inorganic material and a coating layer of a surface treatment agent coating the mother particle.

The average particle diameter of the inorganic particle C3 may be 1 nm or more and 300 nm or less, 5 nm or more and 100 nm or less, or 5 nm or more and 50 nm or less.

Consequently, the inorganic particle C3 is allowed to more suitably adhere to the surface of the thermoplastic particle C2, unintentional detachment of the inorganic particle C3 from the surface of the thermoplastic particle C2 and unintentional burying of the inorganic particle C3 into the inside of the thermoplastic particle C2 can be more suitably prevented, and the above-described effects can be more remarkably exerted.

### 1-1-2-1. Mother Particle

The mother particle of the inorganic particle C3, in other words, the base material surface-treated with the surface treatment agent of the inorganic particle C3 is constituted of an inorganic material.

Examples of the constituent material of the mother particle of the inorganic particle C3 include various metal materials, various metal compounds, various glass materials, and various carbon materials.

Examples of the metal material include single metals, such as Fe, Al, Cu, Ag, and Ni, and alloys including at least one of these metals.

Examples of the metal compound include metal oxides, metal nitrides, metal carbides, and metal sulfides, more specifically, silica, alumina, zirconia, titanium oxide, magnetite, and ferrite.

Examples of the glass material include soda glass, crystalline glass, quartz glass, lead glass, potassium glass, borosilicate glass, and non-alkali glass.

Examples of the carbon material include diamond, carbon fibers, carbon black, carbon nanotubes, carbon nanofibers, and fullerene.

In particular, the constituent material of the mother particle of the inorganic particle C3 may be silica. In other words, the inorganic particle C3 may be constituted of silica surface-treated with a surface treatment agent.

Consequently, the surface treatment with a surface treatment agent for the mother particle can be more suitably performed, and the adhesion between the mother particle and the surface treatment agent can be further improved. As a result, the effects of the present disclosure described above are more remarkably exerted. In addition, silica is a material that is unlikely to adversely affect the color of the molded product manufactured using the complex C10. In particular, when the molded product is paper, this effect is more remarkably exerted. Furthermore, the use of silica as the inorganic particle C3 improves the fluidity of the composite particle C1 constituting the complex C10 and can more uniformly disperse the complex C10 in the mixture described later. Accordingly, the strength of the molded product obtained by dry molding can be more improved.

The mother particle of the inorganic particle C3 may include an organic material in addition to the inorganic material as long as it is mainly constituted of the above-mentioned inorganic material.

However, the content of the inorganic material in the mother particle of the inorganic particle C3 may be 90 mass % or more, 95 mass % or more, or 99 mass % or more.

### 1-1-2-2. Surface Treatment Agent

The inorganic particle C3 includes a mother particle constituted of an inorganic material and a coating layer of a surface treatment agent coating the mother particle.

The surface treatment agent may be at least one selected from the group consisting of fluorine-containing compounds and silicon-containing compounds. Examples of the fluorine-containing compound include perfluoropolyether and fluorine-modified silicone oil. Examples of the silicon-containing compound include various silicone oils, such as dimethylsilicone oil, amino-modified silicone oil, epoxy-modified silicone oil, carboxy-modified silicone oil, carbinol-modified silicone oil, polyether-modified silicone oil, and alkyl-modified silicone oil.

In particular, the surface treatment agent may include at least one of perfluoropolyether and dimethylsilicone oil or may at least include perfluoropolyether.

Consequently, the surface free energy of the complex C10 can be more suitably reduced, and the above-described effects of the present disclosure are more remarkably exerted.

When a fluorine-containing compound and a silicon-containing compound are used as the surface treatment agent, a relationship, 0.0<XS/XF≤4.0, may be satisfied, wherein XF [parts by mass] is the amount of the fluorine-containing compound used in the surface treatment of the mother particle and XS [parts by mass] is the amount of the silicon-containing compound used in the surface treatment of the mother particle, and a relationship of 0.1≤XS/XF≤3.8 or 0.2≤XS/XF≤2.5 may be satisfied.

Consequently, the surface free energy of the complex C10 can be further suitably reduced, and the above-described effects of the present disclosure are further remarkably exerted.

When a plurality of types of the surface treatment agents is used, the surface treatment agents may be used for a single mother particle, or the complex C10 may include particles of the inorganic particle C3 treated with surface treatment agents different from each other.

The content of the surface treatment agent may be 0.1 parts by mass or more and 80 parts by mass or less based on 100 parts by mass of the mother particle included in the complex C10 and may be 1 part by mass or more and 30 parts by mass or less.

Consequently, the above-described effects of the present disclosure are more remarkably exerted.

### 1-1-3. Other Components

The composite particle C1 may further include another component as long as it has a configuration composed of the thermoplastic particle C2 and the inorganic particle C3 adhered to the surface of the thermoplastic particle C2. For example, in the composite particle C1, not oly the inorganic particle C3 but also a particle of an inorganic material corresponding to the mother particle not surface-treated with a surface treatment agent may adhere to the surface of the thermoplastic particle C2.

### 1-2. Other Configurations

The complex C10 may further include another configuration as long as it may include the above-described composite particle C1. For example, the complex C10 of the present disclosure may include the thermoplastic particle C2 to which the inorganic particle C3 does not adhere or the inorganic particle C3 not adhering to the thermoplastic particle C2 in addition to the composite particle C1.

However, the content of the composite particle C1 in the complex C10 may be 50 mass % or more, 70 mass % or more, or 80 mass % or more.

Consequently, the above-described effects are more remarkably exerted.

### 1-3. Other Conditions

The complex C10 may satisfy the following conditions.

For example, a relationship, 0.001≤XI/XT≤0.25, may be satisfied, wherein XT [mass %] is the content of the thermoplastic particle C2 and XI [mass %] is the content of the inorganic particle C3 included in the comples C10, and a relationship of 0.005≤XI/XT≤0.11 or 0.006≤XI/XT≤0.05 may be satisfied.

Consequently, the strength of the molded product manufactured using the complex C10 can be further improved.

In addition, the surface free energy of the complex C10 may be 40 mJ/cm² or less, 37 mJ/cm² or less, or 35 mJ/cm² or less.

Consequently, the above-described effects of the present disclosure are more remarkably exerted.

Incidentally, as the surface free energy of the complex C10, the value determined by measurement as follows can be used.

That is, first, paper including fibers, such as a PPC sheet, is prepared, and a molded product is produced with a sheet-manufacturing apparatus described later. On this occasion, the solid content of the complex is adjusted to be 40 mass % or more based on the total amount of the molded product. A test piece of 10 cm×110 cm is cut out from the produced molded product.

Two types of liquids having known surface tensions are dropped on the molded product including a complex under an environment of 23° C., and the contact angle of each liquid is measured with a dynamic absorption tester (for example, dynamic contact angle tester 1100DAT, manufactured by Fibro System AB). The values measured at 8 randomly selected points are averaged to obtain the contact angle.

In the measurement of surface free energy, after the dropping of droplets of the two types of liquids having known surface tensions, the contact angle at 0 second is determined by interpolation of the contact angles between 0.1 seconds and 1 second, and the equilibrium contact angle excluding the influence of the absorption by paper, i.e., the 0-second contact angle, is calculated. The surface free energy can be determined by using the contact angles determined as described above and the known surface tensions of the two types of liquids. Since the molded product includes a relatively large amount of the complex wetting and spreading by the heating and pressurization step of a method for manufacturing a molded product described later, the value of the surface free energy measured for the molded product can be regarded as the surface free energy of the complex.

### 2. Method for Manufacturing Molded Product

A method for manufacturing a molded product of the present disclosure will now be described.

The method for manufacturing a molded product of the present disclosure includes a deposition step of depositing a mixture including a fiber and the complex of the present disclosure described later and a heating and pressurization step of heating and pressurizing the mixture.

Consequently, a method for manufacturing a molded product that can manufacture a molded product including a fiber and having an excellent strength can be provided.

The fiber is usually the main component of the molded product manufactured by the method for manufacturing a molded product of the present disclosure and is a component of highly contributing to maintain the shape of the molded product and of highly affecting the characteristics, such as the strength of the molded product.

The fiber may be constituted of any material and may be a material that can maintain the fibrous state even by heating in the heating and pressurization step.

The fiber may be a synthetic fiber constituted of a synthetic resin, such as polypropylene, polyester, or polyurethane, but can be a naturally derived fiber, i.e., a biomass-derived fiber or a cellulose fiber.

Consequently, it is possible to more suitably correspond to environmental problems, saving of underground resources, and so on.

In particular, when the fiber is a cellulose fiber, the following effects are also obtained.

That is, cellulose is a plant-derived and abundant natural material, and the use of cellulose as the fiber further suitably corresponds to environmental problems, saving of reserve resources, and so on, and cellulose may be used from the viewpoint of stably supply of a molded product, a reduction in cost, and so on. In addition, among various types of fibers, the cellulose fiber theoretically has a particularly high strength and is advantageous also from the viewpoint of further enhancing the strength of the molded product.

The cellulose fiber is usually mainly constituted of cellulose but may include a component other than cellulose. Examples of such the component include hemicellulose and lignin.

In addition, the cellulose fiber may be one subjected to a treatment, such as bleaching.

In addition, the fiber may be one subjected to a treatment, such as an UV irradiation treatment, an ozone treatment, or a plasma treatment. Consequently, the hydrophilicity of the fiber can be enhanced, and the affinity with the binding material can be enhanced. More specifically, a functional group, such as a hydroxy group, can be introduced to the surface of a fiber by these treatments, and a hydrogen bond with the binding material can be more efficiently formed.

The average length of the fiber is not particularly limited and may be 0.1 mm or more and 50 mm or less, 0.2 mm or more and 5.0 mm or less, or 0.3 mm or more and 3.0 mm or less.

Consequently, the stability of the shape, strength, etc. of the manufactured molded product can be further improved.

The average thickness of the fiber is not particularly limited and may be 0.005 mm or more and 0.5 mm or less or 0.010 mm or more and 0.05 mm or less.

Consequently, the stability of the shape, strength, etc. of the manufactured molded product can be further improved. In addition, it is possible to more effectively prevent unintentional irregularities occurring on the surface of the molded product.

The average aspect ratio, i.e., the ratio of the average length to the average thickness, of the fiber is not particularly limited and may be 10 or more and 1000 or less or 15 or more and 500 or less.

Consequently, the stability of the shape, strength, etc. of the manufactured molded product can be further improved. In addition, it is possible to more effectively prevent unintentional irregularities occurring on the surface of the manufactured molded product.

The heating temperature in the heating and pressurization step is not particularly limited and may be 100° C. or more and 250° C. or less, 120° C. or more and 220° C. or less, or 130° C. or more and 200° C. or less

Consequently, more suitable wet spread of the complex C10 on the surface of the fiber is possible while effectively preventing unintentional degradation, denaturation, etc. of the fiber and the components of the complex C10. As a result, the manufactured molded product can have more excellent strength and reliability. In addition, such heating is advantageous also from the viewpoint of energy saving.

Consequently, the complex C10 can more suitably wet and spread on the surface of the fiber. As a result, the manufactured molded product can have more excellent strength.

The method for manufacturing a molded product of the present disclosure can be suitably implemented using, for example, a manufacturing apparatus of a molded product described below.

### 3. Manufacturing Apparatus of a Molded Product

A manufacturing apparatus of a molded product according to the present disclosure will now be described.

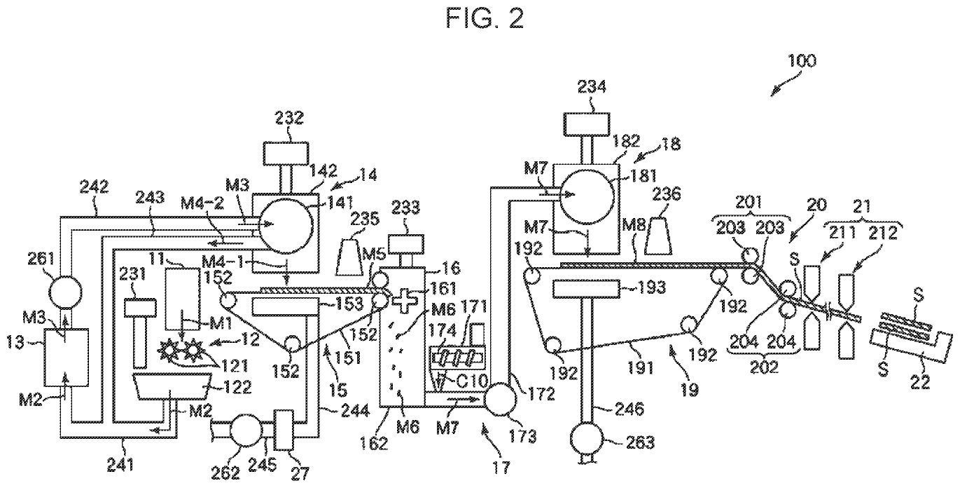

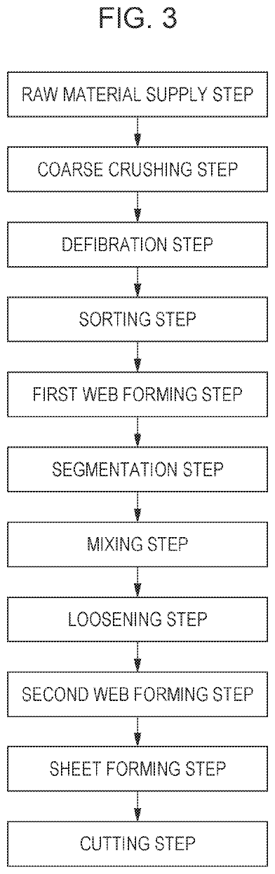

FIG. 2 is a schematic side view illustrating the structure of a manufacturing apparatus of a molded product of an appropriate embodiment. FIG. 3 is a drawing showing the steps implemented sequentially by the manufacturing apparatus of a molded product shown in FIG. 2. Incidentally, in the following, for convenience of description, the upper side in FIG. 2 is referred to as “upper” or “above”, the lower side is referred to as “lower” or “below”, the left side is referred to as “left” or “upstream”, and the right side is referred to as “right” or “downstream”.

In the following description, as an example of the manufacturing apparatus of a molded product, a sheet-manufacturing apparatus for manufacturing a sheet as the molded product will be described as an example.

As shown in FIG. 2, the sheet-manufacturing apparatus 100 as the manufacturing apparatus of a molded product includes a raw material supply unit 11, a coarse crushing unit 12, a defibration unit 13, a sorting unit 14, a first web forming unit 15, a fragmentation unit 16, a mixing unit 17, a loosening unit 18, a second web forming unit 19, a sheet forming unit 20, a cutting unit 21, and a stock unit 22. In addition, the sheet-manufacturing apparatus 100 includes a humidification unit 231, a humidification unit 232, a humidification unit 233, and a humidification unit 234.

The operation of each unit of the sheet-manufacturing apparatus 100 is controlled by a controller unit (not shown).

As shown in FIG. 3, in the present embodiment, the method for manufacturing a sheet as the molded product includes a raw material supply step, a coarse crushing step, a defibration step, a sorting step, a first web forming step, a segmentation step, a mixing step, a loosening step, a second web forming step, a sheet forming step, and a cutting step. The sheet-manufacturing apparatus 100 can implement these steps sequentially.

The structure of each unit of the sheet-manufacturing apparatus 100 will now be described.

The raw material supply unit 11 is a section for performing the raw material supply step of supplying a sheet-like material M1 to the coarse crushing unit 12. This sheet-like material M1 is a sheet-like material including a fiber such as a cellulose fiber.

The coarse crushing unit 12 is a section for performing the coarse crushing step of coarsely crushing the sheet-like material M1 supplied from the raw material supply unit 11 in a gas, such as air. The coarse crushing unit 12 includes a pair of primary crushing blades 121 and a hopper 122.

The pair of primary crushing blades 121 rotate to the opposite directions to each other and can coarsely crush, i.e., cut the sheet-like material M1 therebetween into coarsely crushed pieces M2. The shape and size of the coarsely crushed pieces M2 may be those suitable for the defibration treatment in the defibration unit 13 and may be, for example, small pieces with a side length of 100 mm or less or small pieces with a side length of 10 mm or more and 70 mm or less.

The hopper 122 is disposed below the pair of primary crushing blades 121 and may be, for example, funnel shaped. Consequently, the hopper 122 can receive the coarsely crushed pieces M2 crushed by and falling from the primary crushing blades 121.

The humidification unit 231 is disposed above the hopper 122 to be adjacent to the pair of primary crushing blades 121. The humidification unit 231 humidifies the coarsely crushed pieces M2 in the hopper 122. This humidification unit 231 includes a filter (not shown) including moisture and is constituted of a vaporization humidifier in which humidified air having an increased humidity by allowing air to pass through the filter is supplied to the coarsely crushed pieces M2. The supply of humidified air to the coarsely crushed pieces M2 can prevent the coarsely crushed pieces M2 from adhering to the hopper 122 and so on by static electricity.

The hopper 122 is connected to the defibration unit 13 through a tube 241 serving as a flow channel. The coarsely crushed pieces M2 collected in the hopper 122 passes through the tube 241 and is transported to the defibration unit 13.

The defibration unit 13 is a section for performing the defibration step of defibrating the coarsely crushed pieces M2 in a gas, such as air, i.e., by a dry process. A defibrated substance M3 is generated from the coarsely crushed pieces M2 by a defibration treatment in this defibration unit 13. Here, the term “defibration” means that a coarsely crushed piece M2 composed of multiple fibers bound to each other is loosened into individual fibers. This loosened material is the defibrated substance M3. The shape of the defibrated substance M3 is linear or strip-shaped. The individual defibrated substances M3 may exist in a state of being intertwined and agglomerated, that is, in a state of forming a so-called “lump”.

The defibration unit 13 consists, for example, in the present embodiment, of an impeller mill including a rotor rotating at a high speed and a liner located on the outer circumference of the rotor. The coarsely crushed pieces M2 flowed into the defibration unit 13 are sandwiched between the rotor and the liner and are defibrated.

The defibration unit 13 can generate a flow of air from the coarse crushing unit 12 toward the sorting unit 14, i.e., an airflow, by the rotation of the rotor.

Consequently, the coarsely crushed pieces M2 can be sucked from the tube 241 to the defibration unit 13. In addition, after the defibration treatment, the defibrated substance M3 can be sent to the sorting unit 14 through a tube 242.

In the middle of the tube 242, a blower 261 is provided. The blower 261 is an airflow generator that generates an airflow toward the sorting unit 14. Consequently, the sending out of the defibrated substance M3 to the sorting unit 14 is promoted.

The sorting unit 14 is a section for performing the sorting step of sorting the defibrated substance M3 depending on the length of the individual fibers. In the sorting unit 14, the defibrated substance M3 is sorted into a first sorted substance M4-1 and a second sorted substance M4-2 larger than the first sorted substance M4-1. The first sorted substance M4-1 has a size suitable for subsequent manufacturing of a sheet S. The second sorted substance M4-2 includes, for example, an insufficiently defibrated substance and excessively aggregated product of the defibrated individual fibers.

The sorting unit 14 includes a drum section 141 and a housing section 142 accommodating the drum section 141.

The drum section 141 is a sieve that is constituted of a cylindrically shaped net and rotates around the central axis thereof. The defibrated substance M3 flows into this drum section 141 and is sorted by the rotation of the drum section 141. The defibrated substance M3 smaller than the opening of the net is sorted as the first sorted substance M4-1, and the defibrated substance M3 equal to or larger than the opening of the net is sorted as the second sorted substance M4-2. The first sorted substance M4-1 falls from the drum section 141.

On the other hand, the second sorted substance M4-2 is sent to a tube 243 which is a flow channel connected to the drum section 141. The tube 243 is connected to the tube 241 on the opposite side to the drum section 141, i.e., the upstream. This second sorted substance M4-2 passed through this tube 243 joins to the coarsely crushed pieces M2 in the tube 241 and flows into the defibration unit 13 together with the coarsely crushed pieces M2. Consequently, the second sorted substance M4-2 is sent back to the defibration unit 13 and is subjected to the defibration treatment together with the coarsely crushed pieces M2.

The first sorted substance M4-1 from the drum section 141 falls while being dispersed in air toward the first web forming unit 15 which is a separation section located below the drum section 141. The first web forming unit 15 is a section performing the first web forming step of forming a first web M5 from the first sorted substance M4-1. The first web forming unit 15 includes a mesh belt 151 serving as a separation belt, three stretching rollers 152, and a suction section 153.

The mesh belt 151 is an endless belt, and the first sorted substance M4-1 deposits thereon. This mesh belt 151 is put around the three stretching rollers 152. The first sorted substance M4-1 on the mesh belt 151 is transported to the downstream by rotary drive of the stretching rollers 152.

The first sorted substance M4-1 has a size equal to or larger than the opening of the mesh belt 151. Consequently, the first sorted substance M4-1 is restricted from passing through the mesh belt 151 and can therefore deposit on the mesh belt 151. The first sorted substance M4-1 is transported to the downstream together with the mesh belt while being deposited on the mesh belt 151 and is therefore formed into a layered first web M5.

There is a risk of, for example, contaminating the first sorted substance M4-1 with dust, mote, and so on. The dust and mote may be mixed with the first sorted substance M4-1, for example, together with the sheet-like material M1 when the sheet-like material M1 is supplied to the coarse crushing unit 12 from the raw material supply unit 11. This dust and mote are smaller than the opening of the mesh belt 151. Consequently, dust and mote pass through the mesh belt 151 and further fall down.

The suction section 153 can suck air from the below of the mesh belt 151. Consequently, the dust and mote passed through the mesh belt 151 can be sucked together with air.

The suction section 153 is connected to a collection section 27 through a tube 244 serving as a flow channel. The dust and mote sucked in the suction section 153 are collected in the collection section 27.

The collection section 27 is further connected to a tube 245 serving as a flow channel. In the middle of the tube 245, a blower 262 is provided. By operating this blower 262, a suction force can be generated in the suction section 153. Consequently, formation of a first web M5 on the mesh belt 151 is promoted. In this first web M5, dust and mote have been removed. Dust and mote pass through the tube 244 by operation of the blower 262 and reach the collection section 27.

The housing section 142 is connected to the humidification unit 232. The humidification unit 232 is constituted of a vaporization humidifier similar to the humidification unit 231. Consequently, humidified air is supplied to the inside of the housing section 142. The first sorted substance M4-1 can be humidified by this humidified air. Accordingly, it is also possible to prevent the first sorted substance M4-1 from adhering to the inner wall of the housing section 142 by an electrostatic force.

The humidification unit 235 is disposed on the downstream of the sorting unit 14. The humidification unit 235 is constituted of an ultrasonic humidifier that sprays water. Consequently, moisture can be supplied to the first web M5, and the amount of moisture of the first web M5 is adjusted. This adjustment can prevent the first web M5 from attaching to the mesh belt 151 by an electrostatic force. Consequently, the first web M5 is easily peeled off from the mesh belt 151 at the position where the mesh belt 151 is folded back by the stretching roller 152.

The fragmentation unit 16 is disposed on the downstream of the humidification unit 235. The fragmentation unit 16 is a section for performing the segmentation step of segmenting the first web M5 peeled off from the mesh belt 151. The fragmentation unit 16 includes a rotatably supported propeller 161 and a housing section 162 accommodating the propeller 161. The first web M5 can be segmented by being wound in the rotating propeller 161. The segmented first web M5 becomes a fragment M6. The fragment M6 descends in the housing section 162.

The housing section 162 is connected to the humidification unit 233. The humidification unit 233 is constituted of a vaporization humidifier similar to the humidification unit 231. Consequently, humidified air is supplied to the inside of the housing section 162. This humidified air can prevent the fragment M6 from adhering to the propeller 161 and the inner wall of the housing section 162 by an electrostatic force.

The mixing unit 17 is disposed on the downstream of the fragmentation unit 16. The mixing unit 17 is a section for performing the mixing step of mixing the fragment M6 and the above-described complex C10 of the present disclosure. This mixing unit 17 includes a complex supply section 171, a tube 172 serving as a flow channel, and a blower 173.

The tube 172 connects between the housing section 162 of the fragmentation unit 16 and the housing section 182 of the loosening unit 18 and is a flow channel through which the mixture M7 of the fragment M6 and the complex C10 passes.

In the middle of the tube 172, the complex supply section 171 is connected. The complex supply section 171 includes a screw feeder 174. The complex C10 can be supplied to the tube 172 by rotary drive of this screw feeder 174. The complex C10 supplied to the tube 172 is mixed with the fragment M6 to form a mixture M7.

Incidentally, the complex supply section 171 may supply, in addition to the complex C10, for example, a colorant for coloring the fiber, an aggregation inhibitor for inhibiting aggregation of the fiber and aggregation of the complex C10, and a flame retardant for making the fiber, etc. difficult to burn.

In the middle of the tube 172, a blower 173 is provided on the downstream of the complex supply section 171. The blower 173 can generate an airflow toward the loosening unit 18. This airflow can stir the fragment M6 and the complex C10 in the tube 172. Consequently, the mixture M7 can flow into the loosening unit 18 in the state in which the fragment M6 and the complex C10 are uniformly dispersed. In addition, the fragment M6 in the mixture M7 is loosened to finer fibers in the process of passing through the tube 172.

The loosening unit 18 is a section for performing the loosening step of loosening individual fibers that are intertwined with each other in the mixture M7. The loosening unit 18 includes a drum section 181 and a housing section 182 accommodating the drum section 181.

The drum section 181 is a sieve that is constituted of a cylindrically shaped net and rotates around the central axis thereof. The mixture M7 flows into this drum section 181. In the mixture M7, individual fibers, etc. smaller than the opening of the net can pass through the drum section 181 by the rotation of the drum section 181. On this occasion, the mixture M7 is loosened.

The mixture M7 loosened in the drum section 181 falls while being dispersed in air toward the second web forming unit 19 which is located below the drum section 181. The second web forming unit 19 is a section performing the second web forming step of forming a second web M8 from the mixture M7. The second web forming step in the present embodiment is a deposition step of depositing a mixture including the fiber and the complex C10. The second web forming unit 19 includes a mesh belt 191 serving as a separation belt, stretching rollers 192, and a suction section 193.

The mesh belt 191 is an endless belt, and the mixture M7 deposits thereon. This mesh belt 191 is put around four stretching rollers 192. The mixture M7 on the mesh belt 191 is transported to the downstream by rotary drive of the stretching rollers 192.

Most of the mixture M7 on the mesh belt 191 has a size of equal to or larger than the opening of the mesh belt 191. Consequently, the mixture M7 is restricted from passing through the mesh belt 191 and can deposit on the mesh belt 191. In addition, the mixture M7 is transported to the downstream together with the mesh belt 191 while being deposited on the mesh belt 191 and is therefore formed into a layered second web M8.

The suction section 193 can suck air from the below of the mesh belt 191. Consequently, the mixture M7 can be sucked on the mesh belt 191, and deposition of the mixture M7 on the mesh belt 191 is promoted.

The suction section 193 is connected to a tube 246 serving as a flow channel. In addition, in the middle of this tube 246, a blower 263 is provided. A suction force can be generated in the suction section 193 by operation of this blower 263.

The housing section 182 is connected to the humidification unit 234. The humidification unit 234 is constituted of a vaporization humidifier similar to the humidification unit 231. Consequently, humidified air is supplied to the inside of the housing section 182. The inside of the housing section 182 is humidified by this humidified air, and thereby the mixture M7 can be prevented from adhering to the inner wall of the housing section 182 by an electrostatic force.

The humidification unit 236 is disposed on the downstream of the loosening unit 18. The humidification unit 236 is constituted of an ultrasonic humidifier similar to the humidification unit 235. Consequently, moisture can be supplied to the second web M8, and the amount of moisture in the second web M8 is adjusted. This adjustment can prevent the second web M8 from attaching to the mesh belt 191 by an electrostatic force. Consequently, the second web M8 is easily peeled off from the mesh belt 191 at the position where the mesh belt 191 is folded back by the stretching rollers 192.

The sheet forming unit 20 is disposed on the downstream of the second web forming unit 19. The sheet forming unit 20 is a section for performing the sheet forming step which is a heating and pressurization step of forming a sheet S from the second web M8. This sheet forming unit 20 includes a pressurization section 201 and a heating section 202.

The pressurization section 201 includes a pair of calender rollers 203 and can pressurize the second web M8 therebetween without heating. Consequently, the density of the second web M8 is increased. This second web M8 is transported toward the heating section 202. Incidentally, one of the pair of calender rollers 203 is a driving roller that is driven by operation of a motor (not shown), and the other is a driven roller.

The heating section 202 includes a pair of heating rollers 204 and can pressurize the second web M8 therebetween while heating. The complex C10 is melted in the second web M8 by this heating and pressurization, and individual fibers are bound to each other through this melted complex C10. Consequently, a sheet S is formed as a molded product. This sheet S is transported toward the cutting unit 21. Incidentally, one of the pair of heating rollers 204 is a driving roller that is driven by operation of a motor (not shown), and the other is a driven roller.

The cutting unit 21 is disposed on the downstream of the sheet forming unit 20. The cutting unit 21 is a section for performing the cutting step of cutting the sheet S. This cutting unit 21 includes a first cutter 211 and a second cutter 212.

The first cutter 211 cut the sheet S in a direction intersecting the transport direction of the sheet S.

The second cutter 212 cut the sheet S in a direction parallel to the transport direction of the sheet S on the downstream of the first cutter 211.

A sheet S as a molded product with a desired size can be obtained by the cutting with the first cutter 211 and the second cutter 212. This sheet S is further transported to the downstream and is stored in the stock unit 22.

### 4. Molded Product

The molded product of the present disclosure will be then described.

The molded product of the present disclosure includes a fiber, an inorganic particle surface-treated with at least one surface treatment agent selected from the group consisting of fluorine-containing compounds and silicon-containing compounds, and a thermoplastic material for binding the fiber and the inorganic particle.

Consequently, a molded product including a fiber and also having excellent strength can be provided.

The thermoplastic material and the inorganic particle included in the molded product of the present disclosure may be those satisfying the same conditions as described in the paragraphs “1-1-1” and “1-1-2”, respectively.

The shape of the molded product of the present disclosure is not particularly limited and may be any shape, such as sheet-like, block-like, spherical, and three-dimensional solid shapes. The molded product of the present disclosure may be in a sheet-like shape. Incidentally, the term “sheet-like” here refers to a molded product molded so as to have a thickness of 30 μm or more and 30 mm or less and a density of 0.05 g/cm³ or more and 1.5 g/cm³ or less.

Consequently, for example, the molded product can be suitably used as a recording medium, etc. In addition, more efficient manufacturing is possible by using an apparatus as described above.

When the molded product according to the present disclosure is a sheet-like recording medium, the thickness thereof may be 30 μm or more and 3 mm or less.

Consequently, the molded product can be more suitably used as a recording medium. In addition, more efficient manufacturing is possible by using an apparatus as described above.

When the molded product of the present disclosure is a sheet-like recording medium, the density thereof may be 0.6 g/cm³ or more and 0.9 g/cm³ or less.

Consequently, the molded product can be more suitably used as a recording medium.

Consequently, the molded product can be more suitably used as a liquid absorber.

The molded product of the present disclosure may further include an additional portion as long as it is at least partially manufactured by applying the method for manufacturing a molded product of the present disclosure described above. Furthermore, after the steps described in the method for manufacturing a molded product of the present disclosure, the molded product may be subjected to a post treatment.

The use of the molded product of the present disclosure is not particularly limited, and examples thereof include a recording medium, a liquid absorber, a buffer material, and a sound absorber.

In addition, the molded product of the present disclosure can be suitably manufactured using, for example, the complex of the present disclosure described above and the method for manufacturing a molded product of the present disclosure, but the molded product may be manufactured using any material and method as long as it has a configuration as described above.

Preferred embodiments of the present disclosure have been described above, but the present disclosure is not limited thereto.

For example, each unit constituting the sheet-manufacturing apparatus can be replaced with any configuration that can exert the same function. In addition, any component may be added to the apparatus.

The molded product of the present disclosure is not limited to those manufactured with the above-described apparatus and may be manufactured with any apparatus.

### EXAMPLES

Specific examples of the present disclosure will now be described.

### 5. Preparation of Complex

### Example 1

First, a polyester resin “VYLON 220” manufactured by TOYOBO Co., Ltd. was prepared and was coarsely pulverized and was then pulverized with a hammer mill (manufactured by Dalton Corporation, trade name “Labomill LM-5”) until particles having a diameter of 1 mm or less were obtained. Furthermore, the pulverized particles were pulverized with a jet mill (manufactured by Nippon Pneumatic Mfg. Co., Ltd., trade name “PJM-80SP”) to obtain particles having a maximum particle diameter of 40 μm or less. The resulting particles were sorted with an airflow classifier (manufactured by Nippon Pneumatic Mfg. Co., Ltd., trade name “MDS-3”) to obtain a thermoplastic particle having an average particle diameter of 10.0 μm.

Separately, fumed silica (manufactured by Nippon Aerosil Co., Ltd., trade name “AEROSIL R972” (average particle diameter: 16 nm)) was added to a surface treatment liquid consisting of 50 parts by mass of dimethylsilicone oil as a surface treatment agent and 300 parts by mass of ethyl acetate, followd by stirring mixing and then filtration, drying, and pulverization with a pin mill to obtain an inorganic particle of fumed silica surface-treated with dimethylsilicone oil.

The thermoplastic particle (100 parts by mass) and the inorganic particle (2 parts by mass) obtained above were fed into a blender (manufactured by Waring Labs, trade name “Waring Blender 7012”) and were mixed at a rotation speed of 15600 rpm for 60 seconds to obtain a complex including a composite particle composed of the thermoplastic particle and the inorganic particle adhered to the surface of the thermoplastic particle.

### Example 2

A complex was prepared as in Example 1 except that surface treatment for fumed silica was performed in a surface treatment liquid consisting of 45 parts by mass of dimethylsilicone oil, 5 parts by mass of perfluoropolyether, and 300 parts by mass of ethyl acetate.

### Example 3

A complex was prepared as in Example 1 except that surface treatment for fumed silica was performed in a surface treatment liquid consisting of 35 parts by mass of dimethylsilicone oil, 15 parts by mass of perfluoropolyether, and 300 parts by mass of ethyl acetate.

### Example 4

A complex was prepared as in Example 1 except that surface treatment for fumed silica was performed in a surface treatment liquid consisting of 25 parts by mass of dimethylsilicone oil, 25 parts by mass of perfluoropolyether, and 300 parts by mass of ethyl acetate.

### Example 5

A complex was prepared as in Example 1 except that surface treatment for fumed silica was performed in a surface treatment liquid consisting of 15 parts by mass of dimethylsilicone oil, 35 parts by mass of perfluoropolyether, and 300 parts by mass of ethyl acetate.

### Example 6

A complex was prepared as in Example 1 except that surface treatment for fumed silica was performed in a surface treatment liquid consisting of 5 parts by mass of dimethylsilicone oil, 45 parts by mass of perfluoropolyether, and 300 parts by mass of ethyl acetate.

### Example 7

A complex was prepared as in Example 1 except that surface treatment for fumed silica was performed in a surface treatment liquid consisting of 50 parts by mass of perfluoropolyether and 300 parts by mass of ethyl acetate.

The inorganic particle used for manufacturing the complex of each Example above was in the state in which the surface of the mother particle was surface-treated with a surface treatment agent, which was confirmed by high-performance liquid chromatography as follows. That is, first, inorganic particles in a dry state were immersed in a mixture liquid of hexane and diethyl ether mixed at a mass ratio of 1:1 to allow the surface treatment agent to elute. Subsequently, the eluted mixture liquid was distilled in a nitrogen atmosphere, and the residue was dissolved in tetrahydrofuran to prepare a sample for high-performance liquid chromatography. The sample was supplied to the analytical column at a flow rate of 0.5 mL/min, and the surface treatment agent was detected with a differential refractive index (RI) detector.

### Comparative Example 1

The thermoplastic particle (100 parts by mass) having an average particle diameter of 10 μm prepared as described in Example 1 and fumed silica (1 parts by mass, manufactured by Nippon Aerosil Co., Ltd., trade name “AEROSIL R972” (average particle diameter: 16 nm)) not surface-treated were fed into a blender (manufactured by Waring Labs, trade name “Waring Blender 7012”) and were mixed at a rotation speed of 15600 rpm for 60 seconds to obtain a complex. That is, in this Comparative Example, the surface of fumed silica as the inorganic particle was not subjected to surface treatment with a surface treatment agent.

The configurations of the complexes of Examples and Comparative Example 1 are collectively shown in Table 1. In addition, in Table 1, a composition consisting of only a thermoplastic particle having an average particle diameter 10 μm prepared according to the explanation in Example 1 is shown as Comparative Example 2. In addition, Table 1 also shows the value of XS/XF, wherein XF [parts by mass] is the amount of the fluorine-containing compound used for surface treatment of the mother particle of the inorganic partice and XS [parts by mass] is the amount of the silicon-containing compound used for surface treatment of the mother particle of the inorganic particle, and the value of XI/XT, wherein XT [mass %] is the content of the thermoplastic particle and XI [mass %] is the content of the inorganic particle. Incidentally, in all of Examples, the proportion of the thermoplastic particle constituting the composite particle to the total thermoplastic particle included in the complex was 90 mass % or more, and the proportion of the inorganic particle constituting the composite particle to the total inorganic particle included in the complex was 90 mass % or more.

TABLE 1

| | | | Inorganic particle | | | | | Composite |
|---|---|---|---|---|---|---|---|---|
| | Thermoplastic particle | | Mother particle | | | | | particle |
| | | Average | | Average | | | | Average |
| | | particle | | particle | | | | particle |
| | | diameter | | diameter | Coating layer | | | diameter |
| | Material | [μm] | Material | [nm] | Material | XS/XF | XI/XT | [μm] |
| Example 1 | Polyester | 10.0 | Silica | 16 | Dimethyl silicone oil | — | 0.02 | 10.0 |
| Example 2 | Polyester | 10.0 | Silica | 16 | Dimethyl silicone oil/Perfluoropolyether | 90/10 | 0.02 | 10.0 |
| Example 3 | Polyester | 10.0 | Silica | 16 | Dimethyl silicone oil/Perfluoropolyether | 70/30 | 0.02 | 10.0 |
| Example 4 | Polyester | 10.0 | Silica | 16 | Dimethyl silicone oil/Perfluoropolyether | 50/50 | 0.02 | 10.0 |
| Example 5 | Polyester | 10.0 | Silica | 16 | Dimethyl silicone oil/Perfluoropolyether | 30/70 | 0.02 | 10.0 |
| Example 6 | Polyester | 10.0 | Silica | 16 | Dimethyl silicone oil/Perfluoropolyether | 10/90 | 0.02 | 10.0 |
| Example 7 | Polyester | 10.0 | Silica | 16 | Perfluoropolyether | — | 0.02 | 10.0 |
| Cornparative | Polyester | 10.0 | Silica | 16 | — | — | 0.02 | 10.0 |
| Example 1 | | | | | | | | |
| Cornparative | Polyester | 10.0 | — | — | — | — | — | — |
| Example 2 | | | | | | | | |

### 6. Manufacturing Molded Product

Sheets as molded products were manufactured using the complexes of Examples and Comparative Example 1 as follows.

First, a sheet-manufacturing apparatus as shown in FIG. 2 was prepared, and a PPC sheet (Multi-cut paper white, Toppan Forms Co., Ltd.) serving as a fiber source was prepared as a sheet-like material.

Subsequently, the sheet-like material prepared above was supplied to the raw material supply unit of the sheet-manufacturing apparatus, and the sheet-manufacturing apparatus was driven to perform a coarse crushing step, a defibration step, a sorting step, a first web forming step, a segmentation step, a mixing step, a loosening step, a second web forming step, a sheet forming step, and a cutting step. Thus, an A4 size sheet was manufactured as a molded product. The resulting sheet had a thickness of 130 μm.

On this occasion, the sheet as the finally obtained molded product was adjusted to include 5 parts by mass of the complex based on 20 parts by mass of the fiber as a raw material. In addition, the heating temperature when heating and pressurization were performed in the heating section was 180° C., the pressure when heating and pressurization were performed in the heating section was 25 MPa, and the heating and pressurization time when heating and pressurization were performed in the heating section was 1 second.

Regarding Comparative Example 2, a sheet was manufactured as in above except that a thermoplastic particle was used instead of the complex.

### 7. Evaluation

### 7-1. Surface Free Energy

The surface free energy of each of the complexes of Examples and Comparative Example 1 was determined as follows.

That is, first, a PPC sheet (Multi-cut paper white, Toppan Forms Co., Ltd.) was used as a raw material, and a molded product including the complex was produced by a sheet-manufacturing apparatus. The amount of the complex included in the molded product was adjusted to 40 mass %. A test piece of 10 cm×110 cm was cut out from the produced molded product.

Water and ethylene glycol (manufactured by FUJIFILM Wako Pure Chemical Corporation) whose surface tensions were known were dropped on the molded product including the complex under an environment of 23° C., and the contact angles of the water and ethylene glycol were measured with a dynamic absorption tester (manufactured by Fibro System AB, dynamic contact angle tester 1100DAT). The values measured at 8 randomly selected points were averaged to obtain the contact angle.

Incidentally, in the measurement of surface free energy, after the dropping of droplets of water and ethylene glycol, the contact angle at 0 second was determined by interpolation of the contact angles between 0.1 seconds and 1 second, and the equilibrium contact angle excluding the influence of the absorption by paper, i.e., the 0-second contact angle, was calculated. The surface free energy was determined by using the contact angles determined as described above and the surface tensions of water and ethylene glycol.

Regarding Comparative Example 2, the surface free energy was determined as in above except that a thermoplastic particle was used instead of the complex.

### 7-2. Blocking

A part of each of the complexes of Examples and Comparative Example 1 and the thermoplastic particle of Comparative Example 2 was placed in a glass container and was left to stand at 23° C. for 24 hours, and the condition thereof was visually observed to verify whether or not particle agglomeration, that is, blocking occurred.

### 7-3. Tensile Strength

The sheets of Examples and Comparative Examples obtained in the above “6. Manufacturing molded product” were subjected to a tensile test in accordance with JIS P 8113. For more details, a test piece having a total length of 180 mm was cut out from each sheet and was subjected to a tensile test with an elongation rate of 20 mm/min. The rupture stress (MPa) of the test piece was determined as the tensile strength from the maximum load until the test piece broke and was evaluated according to the following criteria. The tensile test was perfored in accordance with JIS P 8111 under an environment of a temperature of 23° C. and a humidity of 50%.
A: the tensile strength is higher than 24 MPa,
B: the tensile strength is higher than 20 MPa and 24 MPa or less, and
C: the tensile strength is 20 MPa or less.

These results are collectively shown in Table 2.

TABLE 2

| | Surface free energy | | Sheet tensile |
|---|---|---|---|
| | [mJ/cm²] | Blocking | strength |
| Example 1 | 39 | Not occurred | B |
| Example 2 | 38 | Not occurred | B |
| Example 3 | 37 | Not occurred | A |
| Example 4 | 36 | Not occurred | A |
| Example 5 | 35 | Not occurred | A |
| Example 6 | 34 | Not occurred | A |
| Example 7 | 34 | Not occurred | A |
| Comparative | 42 | Not occurred | C |
| Example 1 | | | |
| Comparative | 42 | Occurred | C |
| Example 2 | | | |

As obvious from Table 2, excellent results were obtained in the present disclosure. In contrast, in Comparative Examples, no satisfactory results were obtained.

In addition, complexes were manufactured as in Examples described above except that the average particle diameter of the thermoplastic particle was variously changed within a range of 1.0 μm or more and 100 μm or less, the average particle diameter of the inorganic particle was variously changed within a range of 1 nm or more and 300 nm or less, the average particle diameter of the composite particle was variously changed within a range of 1.0 μm or more and 100 μm or less, and the value of XI/XT, wherein XT [mass %] is the content of the thermoplastic particle and XI [mass %] is the content of the inorganic partice, was variously changed within a range of 0.001 or more and 0.25 or less. These complexes were evaluated as in above, and the results obtained were similar to the above.

What is claimed is:

1. A complex comprising:
a thermoplastic particle constituted of a thermoplastic material; and
an inorganic particle surface-treated with at least one surface treatment agent selected from the group consisting of fluorine-containing compounds and silicon-containing compounds, wherein
the complex further comprises a composite particle composed of the thermoplastic particle and the inorganic particle adhered to the surface of the thermoplastic particle.

2. The complex according to claim 1, wherein
the thermoplastic particle has an average particle diameter of 1.0 μm or more and 100 μm or less.

3. The complex according to claim 1, wherein
the inorganic particle has an average particle diameter of 1 nm or more and 300 nm or less.

4. The complex according to claim 1, wherein
the composite particle has an average particle diameter of 1.0 μm or more and 100 μm or less.

5. The complex according to claim 1, wherein
the complex has a surface free energy of 40 mJ/cm² or less.

6. The complex according to claim 1, wherein
the inorganic particle is silica surface-treated with the surface treatment agent.

7. The complex according to claim 1, wherein
a relationship of 0.001≤XI/XT≤0.25 is satisfied, wherein XT [mass %] is a content of the thermoplastic particle and XI [mass %] is a content of the inorganic particle.

8. A method for manufacturing a molded product, comprising:
a deposition step of depositing a mixture including a fiber and the complex according to claim 1; and
a heating and pressurization step of heating and pressurizing the mixture.

9. A molded product comprising:
a fiber;
an inorganic particle surface-treated with at least one surface treatment agent selected from the group consisting of fluorine-containing compounds and silicon-containing compounds; and
a thermoplastic material for binding the fiber and the inorganic particle.
